(19) United States
(12) Patent Application Publication
(10) Pub. No.: US 2007/0235378 A1
(43) Pub. Date: Oct. 11, 2007

(54) Top Load Liquid Filter Assembly for Use with Treatment Agent; and, Methods

(75) Inventors: Brian Mandt, Shakopee, MN (US); Brent A. Gulsvig, Faribault, MN (US); John R. Hacker, Edina, MN (US)

Correspondence Address: MERCHANT & GOULD PC, P.O. BOX 2903, MINNEAPOLIS, MN, 55402-0903, US

(73) Assignee: Donaldson Corporation Company, Inc., Minneapolis, MN (US)

(21) Appl. No.: 10/591,728

(22) PCT Filed: Mar. 4, 2005
(86) PCT No.: PCT/US05/07091

§ 371 Date: Jun. 11, 2007

Related U.S. Application Data
(60) Provisional application No. 60/550,505, filed on Mar. 5, 2004.
(60) Provisional application No. 60/621,421, filed on Oct. 22, 2004.
(60) Provisional application No. 60/621,426, filed on Oct. 22, 2004.

(51) Int. Cl. B01D 24/46

(52) U.S. Cl. 210/190

(57) ABSTRACT

A top load service cartridge including filter media and a treatment agent storage and release cartridge is provided. The cartridge is configured for diffusion of the treatment agent from the treatment agent storage and release cartridge, into liquid flowing through the filter arrangement. Methods of assembly and descriptions of use are provided.

### CROSS-REFERENCE TO RELATED PROVISIONAL APPLICATION FILING

The present application is related to, and includes the disclosure of (with edits), U.S. Provisional Application 60/550,505 filed Mar. 5, 2004, U.S. Provisional Application 60/621,421 filed Oct. 22, 2004 and U.S. Provisional Application 60/621,426 filed Oct. 22, 2004. The complete disclosures of Provisional Application 60/550,505, Provisional Application 60/621,421 and Provisional Application 60/621,426 are incorporated herein by reference.

### FIELD OF THE INVENTION

The present disclosure relates to liquid filters. It particularly concerns top load liquid filters which include, within a filter assembly, a construction for release of a treatment agent for the liquid being filtered. A particular use for the assemblies described, would be as re-additization filters for lubrication oil, although principles described can be used in association with treatments of other liquids such as fuel, coolant liquids and hydraulic fluids.

### BACKGROUND OF THE INVENTION

In many engine systems a liquid system is provided which needs to be both filtered and treated with an additive or treatment agent. An example is a lubrication oil system for engines. In some instances, the lubrication oil for engines contains an additive package to extend the life of the oil and to improve engine component protection. The additive package is made up of a variety of chemical compounds designed to perform specific functions in the oil. An example of one of the chemical compounds is zinc dithiophosphate (ZDP), which acts as an oxidation inhibitor in the oil. When the oil is heated in the presence of air (for example in a diesel engine) oxidation occurs, increasing the concentration of organic acids. The ZDP acts to inhibit oxidation, thereby decreasing the rate at which the acid is formed. A measure of the effectiveness of the ZDP in the oil is the “total base number” (TBN). The TBN is an indicator of the amount of acid in the oil. As ZDP becomes used up during engine operation, the TBN changes. At a certain defined TBN level, the oil is generally considered to be too acidic to be left in the engine, and thus needs to be replaced with “fresh” oil.

Engine designs are undergoing changes, as a result of increasing emphasis on reduction of emissions from engines, for example as mandated in the United States by the EPA. In some instances the changes cause acid formation in the oil to be more of an issue with respect to service interval, as compared to engines of the past.

The initial additive package depletes in time. What has been needed has been improvements in approaches that allow for re-addition of the ZDP or similar treatment agents to a liquid (such as oil) under controlled conditions, during normal engine operation.

In some vehicles and other equipment, it is desirable to provide a liquid filter assembly which is accessible for servicing from the top and which uses a bowl/cartridge arrangement in which an internal service part is a cartridge that is removed and replaced in use, while the remainder of the filter assembly (bowl, etc.) is retained. A variety of top load arrangements have been developed, to accommodate this. It is desirable to develop such arrangements that also provide for an additive package.

### SUMMARY OF THE INVENTION

According to the present disclosure a top load filter arrangement is provided which includes therein as a service component, a filter containing service cartridge. The cartridge includes a filter cartridge component and a treatment agent storage and release cartridge component, as well as a housing seal arrangement. An example structure is described herein.

The treatment agent storage and release cartridge can be provided with a variety of arrangements for allowing diffusion of treatment agent stored therein, into liquid passing through the service filter cartridge. A diffusion aperture can be provided, which provides for both an initial static flow operation and later diffusion flow operation, in accord with principles described in: U.S. Provisional Application 60/550,504, filed Mar. 5, 2004, incorporated herein by reference; and, a U.S. Provisional Application filed simultaneously herewith on Oct. 22, 2004 under Express Mail # EV 408489237 US entitled “Liquid Filter Assembly For Use With Treatment Agent; and, Methods,” in the name of John R. Hacker, Brian Mandt and Brent A. Gulsvig as inventors, also incorporated herein by reference.

Replacement part or service part disclosure is also provided, as well as methods of assembly and use.

### BRIEF DESCRIPTION OF THE DRAWINGS

FIG. 1 is a schematic cross-sectional view of a filter assembly according to the present disclosure.

FIG. 2 is a cross-sectional view of a service component useable in the assembly of FIG. 1.

FIG. 3 is an exploded, top perspective view of the service component depicted in FIG. 2.

### DETAILED DESCRIPTION

### I. Treatment Agents Used in Liquid Systems—Generally.

The technology presented herein generally concerns liquid systems, such as lubricating oil systems, hydraulic fluid systems, cooling fluid systems or fuel filter systems. The technology more specifically concerns delivery of treatment agents or additives to such systems. Herein the terms “treatment agent,” “additives” and variants thereof, are meant to refer to one or more agents released into the fluid or liquid filter stream, with time. An example of a treatment agent would be ZDP as characterized above for a lubricating oil system.

Particular arrangements characterized herein, are top load arrangements. In such arrangements a serviceable filter components contained within a housing, and is removable therefrom through access provided by a top cover.

In particular, the techniques described herein involve delivery of treatment agents into liquid passing through a housing of a liquid filter assembly. In general, a liquid filter assembly is an assembly through which liquid flows, with filtering by passage through filter media, in use. The treatment agent is preferably delivered into the liquid, from a source within the filter assembly, during application of principles described herein. That is, in the preferred arrangements characterized herein, an assembly (service) component which includes the treatment agent for delivery is contained within the filter assembly. Such arrangements, characterized below, will be referred to as filter arrangements which include an “internal” treatment agent storage and release arrangement, container, cartridge or assembly. Preferred arrangements according to the present disclosure are ones configured to provide for treatment agent delivery into unfiltered liquid; i.e., the treatment agent is delivered into a liquid flow stream before the liquid flow stream is filtered by passage through filter media.

Herein the term “immobilized treatment agent” and variants thereof, is meant to refer to the treatment agent in a form in which it is contained in a treatment agent storage and release assembly container or arrangement, before diffusion into the liquid for treatment. In general “immobilized treatment agent” may be in the form of a solid or a gel.

Herein the term “erosion surface” when used to refer to “immobilized treatment agent,” in an internal storage and release cartridge (assembly or arrangement) is meant to refer to any surface of the immobilized treatment agent which is directly contacted by at least a portion of liquid passing through the filter assembly in use, and thus at which diffusion of the treatment agent into the liquid occurs. That is, an “erosion surface” in this context, is a surface of the immobilized treatment agent which is contacted by liquid, at any given time, during use of the filter assembly.

The term “mobilized treatment agent” and variants thereof, is meant to refer to the treatment agent once diffused into the liquid to be treated. The term is meant to be applicable regardless of the form of diffusion, for example whether it involves dissolution of the treatment agent, or suspension of the treatment agent. That is, the specific mechanism of diffusion is not meant to be indicated by the term “mobilized” in this context.

The current disclosure specifically concerns filter arrangements for liquids which include a delivery system for immobilized treatment agent. This disclosure does not specifically concern the treatment agents themselves. The delivery vehicles described herein are particularly developed for use with gel forms of treatment agents, although alternate forms of treatment agents can be used. Gel forms of certain treatment agents have been developed, for example, by Lubrizol Corp. of Wickliffe, Ohio 44092-2201.

A top load embodiment of liquid filter assemblies including delivery systems for treatment agents is disclosed. In general, the example is a filter assembly preferably developed to conveniently provide for a treatment agent release into liquid, in a top load serviced arrangement. In some arrangements, a controlled variability in rate of treatment agent release into liquid, with time, can be provided. In general, the term “variability in rate of treatment agent release into liquid, with time” is meant to refer to the fact that the referenced arrangements allow for an initial release of treatment agent at a first rate (or rate range), and a later release of treatment agent at a different rate (or rate range). The term “controlled” in this context, is meant to refer to the fact that it is the specific design of the delivery system, which provides for this variability.

The affect of a controlled variability and rate of treatment agent release into the liquid, with time, can, in part, be provided by a configuration for the delivery system that allows for different mechanisms of treatment agent release into the liquid, with time. These are generally referred to herein as a “static” mechanism or process; and, a “dynamic” mechanism or process These terms are used not to refer to the dissolution mechanism of the agent into the liquid, but rather to refer to the nature of liquid flow and liquid contact with respect to the treatment agent.

Specifically, although alternatives are possible, some assemblies employing principles described herewith are configured to operate a portion of the time with a “static” type of diffusion or flow. During this type of operation, treatment agent is contained within a treatment storage and release cartridge in such a fashion that there is initially no actual flow of liquid through the storage and release cartridge during this period of “static” flow operation. Rather, diffusion of the treatment agent through a wall of the storage and release cartridge and into surrounding liquid is conducted, during this portion of operation. The term “static” is used to refer to the flow or diffusion under this operation, in which there is no actual continuous current of liquid through the storage and release cartridge, during this portion of operation. In general, during “static” flow operation, the subassembly which includes the treatment agent has liquid flow which enters and exits through the same aperture(s). That is, there is no internal flow channel provided, which allows the liquid to enter one aperture or set of apertures, and then to exit through a second aperture or second set of apertures.

After an initial period of static-type diffusion, in certain configurations according to the present disclosure, there is a second operation implemented that is referred to herein as a “dynamic” flow operation. In this type of operation, treatment agent, contained within the treatment storage and release cartridge, is contacted by a portion of liquid flow directed through the treatment agent storage and release cartridge in use, to pick up treatment agent by diffusion into the liquid flow. More specifically, during this type of operation some liquid flow is directed through the sub-assembly by passage into a liquid flow inlet arrangement, and then eventual passage outwardly through a separate liquid flow outlet arrangement. This type of operation is referenced herein as “dynamic” because there is an actual liquid current flow generated through the sub-assembly.

In both the “dynamic” and “static” flow operations, the treatment agent diffuses into the liquid to be filtered. However, in the dynamic flow operation, treatment agent release can be designed to occur at a relatively fast rate, by comparison to diffusion during an earlier static flow operation, if desired.

It is noted that the techniques described herein, to provide for treatment agent release from a cartridge within a filter arrangement, techniques can be applied, to advantage, to arrangements that are not configured for both a period of static flow operation and a period of dynamic flow operation. Thus, the principles described herein can be applied in arrangements that are only configured for dynamic flow operation or are only configured for static flow operation.

### II. Top Load Liquid Filter Assembly Including a Treatment Agent Storage and Release Arrangement

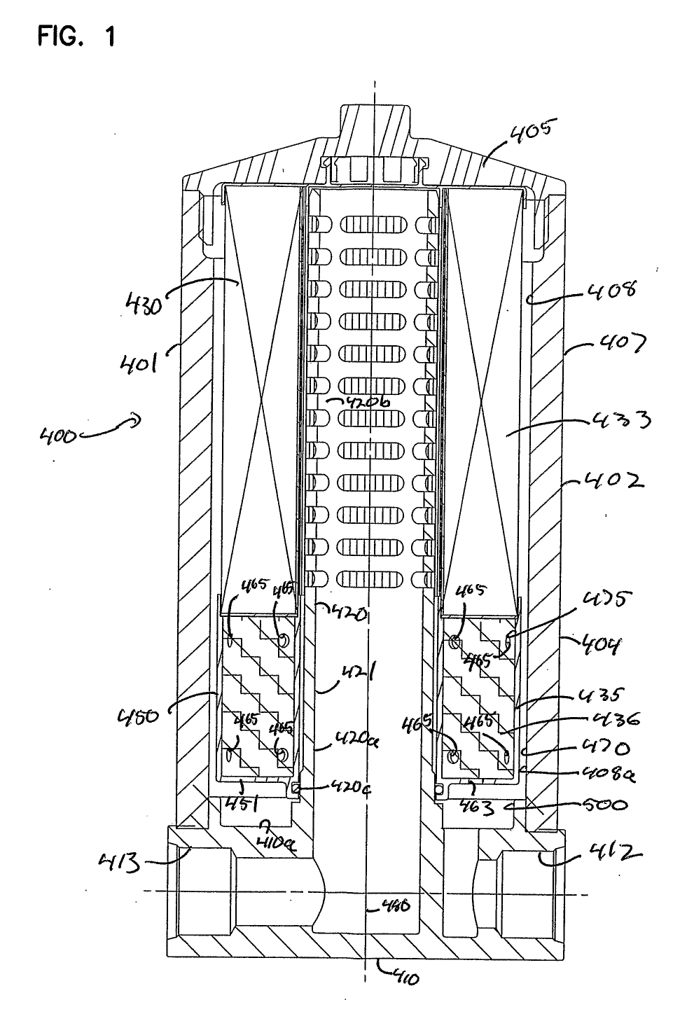

A. Structure of the Arrangement of FIGS. 1-3.

The techniques for the present disclosure are implemented in the form of a bowl/cartridge filter assembly, in which the filter cartridge and treatment agent storage and release cartridge are replacement (i.e. service) parts. One potential arrangement for such a bowl/cartridge application, is as a “top load” application. The term “top load” in this context, is meant to refer to am arrangement in which the filter assembly has a cover that is removed upwardly, and then the cartridge is pulled out the top of the filter housing. An example of a top load arrangement is illustrated in FIGS. 1-3.

Referring to FIG. 1, at 400 a liquid filter assembly is shown, in this instance comprising a top load filter assembly 401. The assembly 400 comprises a housing 402 having a housing bottom 404 and a removable access or service cover 405. The cover 405 can be attached to the housing bottom 404 in a variety of ways, typically a threaded engagement being used. An o-ring seal, or similar seal, not shown, can be used between the housing 404 and a cover 405.

The housing 404 comprises side wall 407, defining interior 408, and base 410.

The base 410 can be configured in a variety of manners. The particular base 410 shown, forms a bottom 410a to interior 408, and includes an inlet flow arrangement 412 and an exit flow arrangement 413; the arrangement 400 being configured for out-to-in flow through an internally received filter cartridge 430.

Assembly 400 further includes central standpipe 420 therein. The standpipe 420 defines an internal flow conduit 421 in direct flow communication with outlet 413. By “direct flow communication” in this context, it is meant that flow from conduit 421 to outlet 413 can occur without passage through serviceable filter cartridge 430.

Although alternatives are possible, the particular standpipe 420 depicted, includes a lower liquid impermeable wall section 420a and an upper liquid permeable wall section 420b.

The standpipe 420 can be a separate component from base 410; a component which is attached to the base 410; or, it can be formed integrally as a single part, with base 410. In the latter two instances, the standpipe 420 will be characterized herein as a portion of the housing 402, since the standpipe 420 is not removed from the housing 402, during normal servicing.

An outer surface of wall section 420a, located at 420c, comprises a seal surface for sealing there against of a seal arrangement (housing seal) of filter cartridge 430. Thus, for the embodiment shown, the cartridge housing seal is made against the standpipe 420, although alternatives are possible.

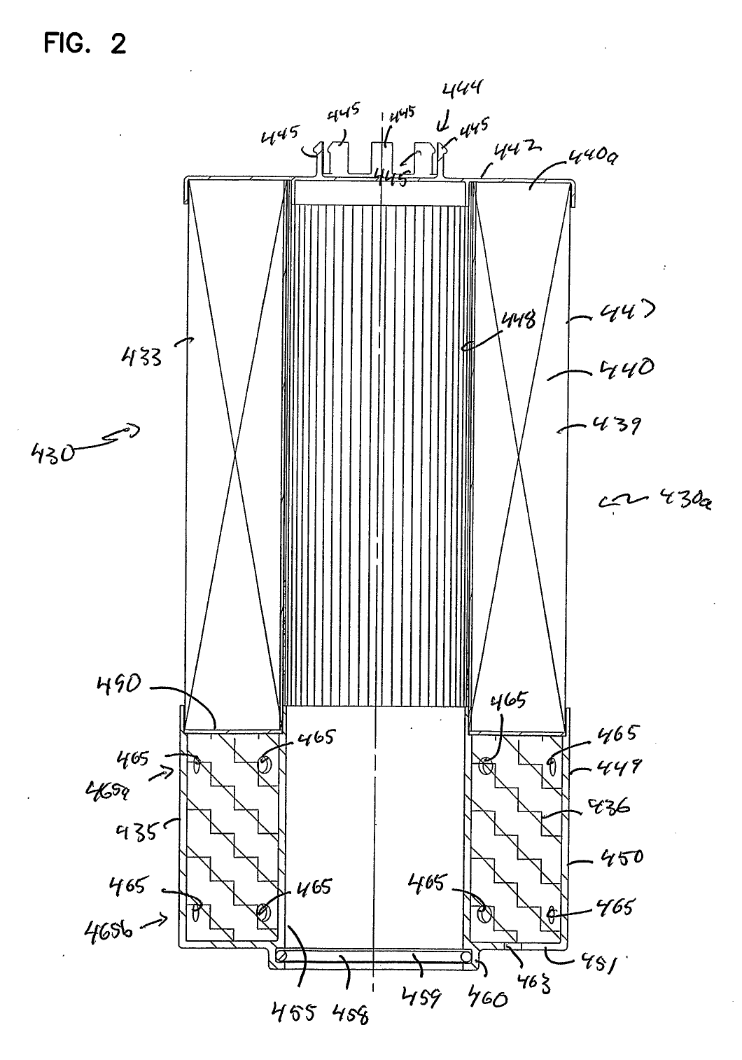

The filter or service cartridge 430 is depicted in FIG. 2. The filter cartridge 430 comprises a media filter cartridge 433 and a treatment agent storage and release cartridge 435, shown with treatment agent 436 therein. As characterized above, the filter cartridge 430, for the example shown, is configured for out-to-in flow during filtering. Of course it could be configured for an alternate flow path, if desired.

The filter cartridge 430 and the treatment agent storage and release cartridge 433 can be made as separate components. However, for the particular assembly 400 shown in FIGS. 1-3, the treatment agent storage and release cartridge 435 and the filter cartridge 430 are secured to one another, to form a single or integral service component 430a. The term “service component” in this context, is meant to refer to a component that, with time, is removed from the housing 402 and is replaced. The terms “integral” and “single” in this context, refer to parts that are not normally separated from one another when servicing is conducted, at least without destruction.

It is noted that for assembly 400, the filter cartridge 433 is positioned above the treatment agent storage and release cartridge 435, although an alternate configuration is possible.

Referring to FIG. 2, for the particular example shown, the cartridge 430 is a media construction and includes, for media 439 within cartridge 433, pleated media 440, although alternate media can be used. The media 440 is secured, at end 440a, to end cap 442. The end cap 442 can be formed from a variety of materials and can be attached to the media at 440a in a variety of ways. Typically the end cap 442 would either be a molded, preformed, plastic piece, to which the media 440 is secured by potting with an adhesive or similar material; or, the end cap 442 would be molded to the media 440.

The specific materials of the media 439 of filter cartridge 433 are a matter of design choice. Typically for liquid filters, the filter media 439 will comprise a media of cellulose, a synthetic or a composite of the two. The selection of media is a matter of design choice, for a desired efficiency, flow restriction and lifetime. A variety of materials are useable. Donaldson Company, Inc., the owner of this disclosure, markets products using its proprietary media technology under the mark Synteqi, and such media can be used for applications described herein. An example of a useable Synteq™ media has an efficiency range of average Beta₁₀=2.0 and Beta₂₂=75.

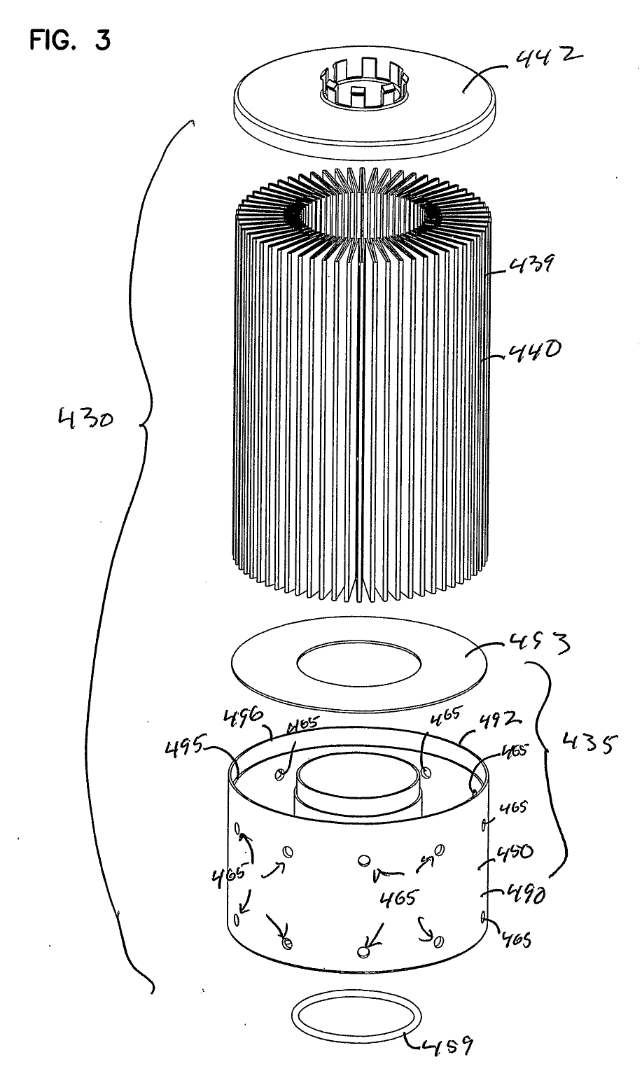

As will be apparent from an evaluation of FIG. 1, the cartridge 433 can be formed as a molded configuration or from bent, stamped, or spun metal pieces. The particular cartridge 433 depicted, has a molded construction. For example it (and end cap 442) may be molded from a glass filled polymer, such as glass filled (for example 33% glass filled) Nylon (for example Nylon 6/6). An example is shown in FIG. 3, discussed below.

For the example shown, end cap 442 is a closed end cap and includes no apertures therethrough. Alternate arrangements are useable, for example ones in which a bypass valve is attached to end cap 442. In still a further alternate version, end cap 442 would have a central aperture, for engagement of the bypass valve arrangement permanently positioned within standpipe 420. This latter end cap would be referred to as an “open” end cap, since it would not be closed when the service component 430 is handled.

Projecting axially outwardly from an outside surface 442a of end cap 442 is a projection arrangement 444, in this instance comprising radially spaced prongs 445. The prongs 445 (projection arrangement 444) are (is) configured to engage a portion of the cover 405, FIG. 13, when installed. Thus when a cover 405 is rotated and separated from the housing 404, the cartridge 430 stays engaged to the cover, until a snap-fit (i.e., releasable) connection provided by the prongs 445 (projection arrangement 444) is broken. (The projection arrangement 444 (prongs 445) can be configured to allow the cover 405 to rotate without rotating the cartridge 430, if desired.) Thus, the projection arrangement 444 releaseably secures the service cartridge 430 to the top cover 405.

With out-to-in flow, the upstream side of the media 440 is indicated generally at 447, the downstream side at 448. The particular cartridge 430 depicted, includes no inner liner adjacent downstream edge 448, although an inner liner could be used in some arrangements.

The media 440 (439) can be provided in a variety of forms conventional for liquid filter media, including, for example, with screen or mesh on the upstream side, downstream side or both, as desired.

The media 439 (pleated media 440) is configured in a form having the media 439 surrounding an open central area defined at downstream side 448.

The treatment agent storage and release cartridge 435 comprises a cup 449 having a ring or doughnut configuration with outer sidewall 450, base or end wall 451 and inner sidewall 452. In the example shown, the inner wall 452 is liquid impermeable, although alternatives are possible. Base or end wall 451 includes a central flow aperture 455 therethrough, defining a flow conduit or passage way in conjunction with wall 452, to receive filtered liquid from the media 439, during use. Housing seal arrangement 458 is provided, for sealing to the housing 402, in this instance standpipe 420, FIG. 1, in use. The particular seal arrangement 458 shown is a radial seal, with o-ring 459 providing the sealing. The o-ring 459 is secured in place, within axial projection 460.

In general, treatment agent storage and release cartridges, such as cartridge 435, FIG. 2, characterized herein include an aperture arrangement through which liquid can pass, to encounter contained, immobilized, treatment agent. Such an “aperture arrangement” or “open portion” will be referred to herein as a “diffusion opening.” The total open area of the diffusion opening(s) will be referred to herein as the “total diffusion area.” In general, one or more diffusion openings can be provided in a variety of ways, including, for example, by aperture arrangement 465 in the outer side wall 450 of the cartridge 435. For the particular treatment agent storage and release cartridge 435 depicted, there are no diffusion apertures or openings in the inner side wall 455 (i.e., on the filtered liquid side of seal 459). That is, the diffusion apertures are only on the upstream (unfiltered liquid) side of the seal 459. Thus, for the assembly 400 shown, treatment agent can only diffuse into unfiltered liquid.

The particular size, number and location of diffusion openings 465 in outer side wall 450 is a matter of choice, depending upon diffusion affects desired. The issue is discussed in greater detail below, in association with some comments about certain possible arrangements.

Still referring to FIG. 2, it is noted that the treatment agent storage and release cartridge 435 further includes aperture arrangement 463 in end wall 451. Examples of size and individual aperture arrangements of this aperture arrangement 463, for the embodiment shown, are discussed below.

It is anticipated that the cartridge 435 can be used with a gel-type treatment agent that has enough solidity to stay in the cartridge 435, when the service cartridge 430 is assembled, although alternative materials could be used. The gel 436 could be set in the cup 449, prior to assembly of the service cartridge 430.

If the consistency of solidity of treatment agent 436 is perceived to be an issue with respect to undesired or premature flow through aperture arrangements 465 or 463, a screen or other arrangement across these apertures can be used; or, in the case of a gel, a temporary closure can be used as the gel forms.

Although alternatives are possible, one useable type of diffusion aperture arrangement is an arrangement that provide for an initial static flow operation and a later dynamic flow operation, using principles described in U.S. Provisional Application 60/550,505, filed Mar. 5, 2004, incorporated herein by reference and/or a U.S. Provisional application concurrently filed on Oct. 22, 2004 under Express Mail # EV 408489237 US entitled “Liquid Filter Assembly For Use With Treatment Agent; and, Methods,” in the name of John R. Hacker, Brian Mandt and Brent A. Gulsvig as inventors, also incorporated herein by reference.

For the example shown, aperture arrangement 465 comprises two vertically spaced sets of apertures, otherwise identical, positioned (typically evenly spaced) in a top row 465a and a bottom row 465b. For a typical arrangement, each of rows 465a, 465b would comprise 6-14, typically 8-10 apertures, although alternatives are possible.

Aperture arrangement 463 and end wall 451 generally comprises a plurality of apertures, typically positioned in a ring around projection 460. Typically there would be about 3-8 such apertures, usually 4-6, for example 5, typically evenly spaced.

Referring to FIG. 1, operation of the filter cartridge 430 will be generally understood. As liquid to be filtered flows in through inlet 412 into annulus 470, it passes across aperture arrangement 463 and aperture arrangement 465. Treatment agent 436 within interior 475 of cartridge arrangement or portion 435, can diffuse into the liquid. The liquid then passes through the media pack 433 of the cartridge 430, through a porous section 420b of standpipe 420, and outwardly through outlet 413. Seal arrangement 458 inhibits unfiltered liquid from reaching outlet 413. Again, a bypass arrangement can be provided if desired.

The particular aperture arrangements 463, 465 depicted, will operate as described below, providing for an initial static diffusion and a follow-up dynamic diffusion, as the treatment agent within interior 475 disperses.

This operation is facilitated, by ensuring that annulus section 408a, between cup 449 and wall 407 is relatively small, so that fluid flow thereacross is at a high rate relative to rate of flow across end wall or base 451.

The relative size of the media pack 433 and treatment agent storage and release cartridge portion 435, particularly with respect to axial length, is a matter of choice for the particular system involved. The issue will generally relate to a desired lifetime before the media 433 needs to be changed being matched as closely as possible with the desired lifetime before the treatment agent is fully dispersed. Typically the axial length ratio, media to storage and release cartridge (interior), will be at least 1.5 usually at least 2.0 and typically within the range of 2.2 to 3.0.

It is noted that a filter cartridge 430 as described, can be retrofit to a previous top load arrangement, which only had a filter media cartridge as a serviceable component. Thus, the invention provides a convenient, simple to use, way of extending service life of a liquid in machinery such as a vehicle. Simply replace a top load filter cartridge therein, with a service component as described herein.

Herein the term “axial” and “axially” when used in the various contexts, is meant to refer to in a direction of longitudinal extension of central axis 480. The term “radial” and variants thereof, is meant to refer to a direction toward or away from, i.e., generally orthogonal to, axis 480.

Attention is now directed to FIG. 3. From FIG. 3, an assembly of cartridge 430 will be understood.

Referring to FIG. 3, the media pack 439 coniprises pleated media 440 arranged in a coiled, in this instance cylindrical, pattern. End piece or end cap 442, is as previously described, for example a molded part to be potted to media pack 439.

The treatment agent storage and release cartridge or sub-assembly 435 is depicted as a molded pre-formed component comprising a container or cup 490 having outer sidewall 450, base or end wall 451 and inner sidewall 452 as previously described. The cup or container 490 has an open end 492 which is closed, during assembly, by ring 493, typically a molded part. Preferably the cup 490 includes a shelf 495 recessed from edge 496. After ring 493 is put in position (over treatment agent positioned within interior 499 to form a sub-assembly) media pack 440 can be potted in a resulting trough 490, FIG. 2 using a variety of materials for example a sealant or adhesive.

The service component 430 can be manufactured in a “metal-free” form, if desired, to facilitate disposal. By “metal-free” it is meant that the component, in total, contains no more than 5% by weight metal. Typically it would no more than 2%, most preferably 0% metal, by wt.

B. Further Detail Regarding a Particular Selected Diffusion Aperture Arrangement.

Referring to FIG. 1, surfaces portions of the treatment agent 436, in overlap with aperture arrangements 463, 465, are initial erosion surfaces for treatment agent to diffuse into flow of liquid to be filtered, in annular region 408a. Specifically, when liquid flow first enters region 500 by passage through inlet arrangement 412, and begins to flow over surfaces of, and around, treatment agent storage and release cartridge 435 and filter cartridge 433, the liquid will flow past aperture arrangements 463, 465. This flow will tend to erode the treatment agent 436 immediately inside these aperture arrangements 463, 465 through diffusion of the agent 436 into the liquid. This will be a static-type of diffusion, since the liquid flow, initially, will not be into and through the treatment agent storage and release cartridge 435, but rather will simply be across the outer faces of cartridge 435; with some liquid passing into the aperture arrangements 463, 465 enough to encounter the treatment agent 436 but not with an actual current flow passing through the cartridge 435.

In time, as a result of the erosion of the treatment agent 436, flow paths will tend to be opened in interior 475 of treatment agent storage and release cartridge 435 between and among various apertures in the aperture arrangements 463, 465. In general, when this occurs a positive current of liquid flow through the treatment agent storage and release cartridge 435 can occur. To facilitate such a positive current flow through the storage and release cartridge 435, the following is desirable: a total diffusion area for aperture arrangement 463 (in end wall 451) which is less than the total diffusion area of exposed apertures in aperture arrangement 465 (in side wall 450) which are in internal flow contact with aperture arrangement 463 as a result of the erosion. The term “internal flow contact” in this context, refers to flow between apertures via one or more flow channels formed and located within interior 475 of cartridge 435.

In general, liquid flow across an aperture creates a vacuum draw from inside of that aperture. Also, in general, the more rapid the liquid flow across an aperture, the greater the vacuum draw.

Referring to FIG. 1, in region 500, internally of inlet 412 and below wall 451, an open volume for liquid flow is provided. Eventually that same liquid flows into region 408a, around cartridge 435 between cartridge 435 and side wall 407. In general, the same volume of liquid, per unit time, passes through regions 500 and 408a, over portions of cartridge 435. However because in the region of 500 a larger cross-sectional volume is provided than in region 408a, flow in region 500 is slower (in terms of flow contact across wall 451), then flow in region 408a (in terms of flow contact across wall 450). Thus, suction draw caused by liquid flow across an aperture in side wall 450 is greater than suction draw by flow across apertures in end wall 451.

Still referring to FIG. 1, an internal flow path between aperture arrangement 463 and apertures of aperture arrangement 465, will be generated as a result of erosion. When this occurs, liquid flow from individual apertures 463 of aperture arrangement 463 into cartridge 435 and then outwardly through individual apertures 465 of aperture arrangement 465 will be generated. Because: (a) preferably the total diffusion area of aperture arrangement 465 is greater than the total diffusion area of aperture arrangement 463; and (b) the annular liquid flow across aperture arrangement 465 is preferably faster than across aperture arrangement 463, this internal flow direction will generally be into aperture arrangement 463 and out of aperture arrangement 465. This initial flow will primarily involve row 465b of apertures 465, FIG. 2.

This internal dynamic flow at least initially results in greater diffusion rate of treatment agent within the cartridge 435, into the liquid flow, then the initial “static” erosion. Eventually aperture row 465a, FIG. 2, will also become exposed to a flow path from aperture arrangement 463. This will allow dynamic flow of liquid into apertures 463 and out of apertures in row 465a as well as 465b.

It is noted that the diffusion rate will be somewhat variable, as erosion occurs and the amount arid shape of the treatment agent 436 changes. However, in general terms (for typical arrangements), diffusion will accelerate when the arrangement becomes configured (as a result of erosion) for dynamic fluid flow through the cartridge 435, as opposed to simply a static diffusion from internally of the cartridge 435 to externally.

Although not depicted, for the particular example shown, five spaced apertures 463 in aperture arrangement 463 are used, although alternatives are possible. Typically 3-7 (preferably evenly) spaced apertures 463a will be used.

In addition, for the example shown, eight to ten (typically 6-14), (preferably evenly) spaced apertures in row 465a, and eight to ten (typically 6-14) spaced (preferably evenly spaced) apertures in row 465b are used in aperture arrangements 465, although alternatives are possible. For the example shown, the size of apertures 465 are all about the same, and the size of apertures 463 are all about the same, although alternatives are possible. The configuration used ensures that there is generally at least 1.5 times, and typically about twice, the total diffusion area for each of rows 465a, 465b than arrangement 463. This helps ensure the desirable level of, and direction of, dynamic current flow.

The number of, and size of, apertures can be selected for any particular system, depending upon the amount of treatment agent release that is desirable. It is noted that apertures in rows 465a, 465b can be merged into one another, as single large apertures, with a variety of alternate shapes to accomplish the desired results.

If settling of treatment agent 436 within cartridge 435 is believed to be an issue, stems can be put around apertures 463 to project into cartridge 435 and cause the erosion surface to at least partially develop above the treatment agent 435.

In general, it is desirable that the rate of treatment agent release into a system such as a lubricating oil system, is relatively slow during initial operation of the assembly 400 after installation of cartridge 430. This is because installation of the assembly 400 will generally be concurrent with an oil change. Thus, the oil would not yet have been subject, as a result of engine operation, to undesirable compositional change. In general, the cartridge 435 is preferably configured to only allow a relatively slow amount of treatment agent release primarily through static diffusion process, during the initial operation of the equipment under these conditions, at least up to about the first 200 hours of operation (more preferably at least the first 250 hours of operation, sometimes up to the first 300 hours of operation), for a typical diesel engine in a vehicle such as a truck. Preferably the apertures are positioned such that a dynamic flow operation will become substantial at the latest by about 350 hours of operation and in some instances as early as 250-300 hours operation, leading to an accelerated rate of treatment agent release into the system.

By the above, it is meant that preferably there is little dynamic flow operation if any, prior to at least 200 hours of operation with the assembly, but there is substantial dynamic flow operation by at the latest 350 hours of operation. The particular mode of operation in between these two limits, is a matter of choice and design. Typically the arrangement will be configured for primarily static flow operation at least up until about 250 hours of operation and in some instances up to about 300 hours of operation.

Typically the apertures in aperture arrangement 463 will not be smaller than 1 mm in diameter, and typically they will be at least 3 mm in diameter, most often at least 5 mm in diameter. Further they will typically have a total diffusion area size of at least 40 sq. mm. or larger.

Whether the apertures in aperture arrangement 463 are circular or not, typically each is at least 1 sq. mm in size, usually at least 8 sq. mm in size, often at least 15 sq. mm in size. Usually there are at least two apertures in aperture arrangement 463.

With respect to the apertures in aperture arrangement 465, if round typically each aperture is at least 1 mm in diameter, usually at least 3 mm in diameter, often preferably 5 mm or more. Typically the area of each, whether round or otherwise, is at least 1 sq. mm, usually at least 8 sq. mm, and often at least 15 sq. mm. Examples of sizes, numbers and patterns are provided herein.

For the example shown, although alternatives are possible, apertures in row 465b of aperture arrangement 465 are located spaced from end wall 451 a distance within 25% of an axial length of treatment agent storage and release cartridge 435 (i.e., approximately a length of wall 450).

Although alternatives are possible, for the example shown apertures in row 465a of aperture arrangement 465 are located at least 60% of an axial length of cartridge 435 (i.e., a length of side wall 450), from end wall 451, typically at least 70% of this length.

Although alternatives are possible, for the example shown the aperture arrangement 463 has a total cross-sectional area of at least 55 sq. mm, typically 55 sq. mm-120 sq. mm. Typically the total diffusion area of apertures in row 465b is at least 50% greater than this, usually at least about 100% greater than this. Similarly, a total diffusion area of apertures in row 465a is typically at least 50% greater than the total aperture area of aperture arrangement 463, usually at least about 100% greater. For typical applications, the total aperture area or diffusion area of apertures in side wall 450 is at least 50% greater than, often at least 100% greater than, and typically 100%-200% greater than, a total diffusion area apertures and end wall 451.

For an example as shown, the remaining dimensions would be as appropriate, to provide the arrangement of FIG. 1, although alternatives are possible.

What is claimed is:

1. A service cartridge for positioning in a filter housing; the service cartridge comprising:
(a) filter media having first and second ends and positioned around a central open area;
(b) a first end cap secured to the first end of the filter media; and,
(c) a treatment agent storage and release cartridge secured to the second end of the media;
(i) the treatment agent storage and release cartridge having a ring configuration defining an inside wall defining a central flow conduit in liquid flow communication with the central open area defined by the filter media;
(A) the inside wall having no diffusion apertures therethrough; and,
(d) a housing seal arrangement.

2. A filter cartridge according to claim 1 wherein:
(a) the housing seal arrangement comprises a radial seal positioned on the treatment agent storage and release cartridge.

3. A filter cartridge according to claim 2 wherein:
(a) the treatment agent storage and release cartridge includes a diffusion aperture arrangement on an upstream side of the housing seal arrangement.

4. A filter cartridge according to claim 3 wherein:
(a) the treatment agent storage and release cartridge comprises a cup having a cover;
(i) the filter media being potted to the cover.

5. A filter cartridge according to claim 4 including:
(a) a mounting prong arrangement projecting axially outwardly from the first end cap.

6. A filter cartridge according to claim 5 wherein:
(a) the media is pleated media.

7. A filter cartridge according to claim 6 wherein:
(a) the cartridge includes no cylindrical media support liner.

8. A filter cartridge according to claim 7 wherein:
(a) an axial length ratio of the filter media to the treatment agent storage and release cartridge is at least 1.5.

9. A filter cartridge according to claim 7 wherein:
(a) an axial length ratio of the filter media to the treatment agent storage and release cartridge is at least 2.0.

10. A filter cartridge according to claim 9 wherein:
(a) the axial length ratio of the filter media to the treatment agent storage and release cartridge is within the range of 2.2 to 3.0.

11. A filter cartridge according to claim 10 wherein:
(a) the first end cap is a closed end cap.

12. A filter assembly comprising:
(a) a housing comprising a bottom portion and a top cover;
(i) the bottom portion having a sidewall and a base;
(A) the base including a liquid flow inlet and a liquid flow outlet; and,
(B) the sidewall defining a housing interior; and,
(b) a service cartridge according to claim 1 operably positioned within the housing.

13. A filter assembly according to claim 12 wherein:
(a) the housing includes a central standpipe; and,
(b) the service cartridge is sealed to the standpipe.

14. A filter assembly according to claim 13 wherein:
(a) the service cartridge is according to claim 5;
(i) the prong arrangement releaseably securing the service cartridge to the top cover.

15. A filter assembly according to claim 14 wherein:
(a) the service cartridge is according to claim 7.

16. A filter assembly according to claim 15 wherein:
(a) the service cartridge is according to claim 10.

17. A filter assembly according to claim 16 wherein:
(a) the service cartridge is according to claim 11.
